(19) United States
(12) Patent Application Publication
(10) Pub. No.: US 2009/0228776 A1
(43) Pub. Date: Sep. 10, 2009

(54) DYNAMIC FORMULAS FOR SPREADSHEET CELLS

(75) Inventors: Allan Folting, Redmond, WA (US); Jeffrey J. Duzak, Redmond, WA (US); Charles D. Ellis, Seattle, WA (US)

Correspondence Address: MERCHANT & GOULD (MICROSOFT), P.O. BOX 2903, MINNEAPOLIS, MN, 55402-0903, US

(73) Assignee: Microsoft Corporation, Redmond, WA (US)

(21) Appl. No.: 12/042,500

(22) Filed: Mar. 5, 2008

(51) Int. Cl. G06F 17/00

(52) U.S. Cl. 715/219

(57) ABSTRACT

Multiple formulas are associated with a single cell of a spreadsheet. A base formula represents the actual value extracted from a data source. Adjustment formulas represent formulas for calculating adjustments to the value contained within the cell and other formulas can represent different calculation scenarios. Each of the formulas associated with the cell are dynamically updated and adjusted to react to changes elsewhere in the spreadsheet such that a user can recalculate the whole spreadsheet and move formulas around in the spreadsheet causing both the external data formula and all the adjustment formulas that may exist in the same cell to be updated accordingly.

### BACKGROUND

Businesses often perform a what-if analysis to determine what effect changes to one or more values would have on a business unit. For example, when performing budgeting and forecasting operations, or simply gathering business metrics, businesses often rely on what-if analysis solutions that allow them to adjust existing numbers and then calculate the effect of that adjustment on the dependent numbers. For more complicated scenarios, these adjustments may be made using formulas instead of fixed values.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

More than one formula is associated with a single cell of a spreadsheet. One of the formulas is a base formula and represents an actual value extracted from a data source. Another one of the formulas represents an adjustment formula that is used for calculating an adjustment to the value contained within the cell. The other adjustment formulas can represent other different calculation scenarios. The formulas associated with the spreadsheet cell are dynamically updated and adjusted to react to changes elsewhere in the spreadsheet such that a user can recalculate the whole spreadsheet and move formulas around in the spreadsheet causing both the base formula and all the adjustment formulas that may exist in the same cell to be updated accordingly.

### BRIEF DESCRIPTION OF THE DRAWINGS

FIG. 1 illustrates an exemplary computing device;

FIG. 2 shows a system for associating multiple formulas with a single spreadsheet cell; and

FIG. 3 illustrates a process for associating multiple formulas with a single spreadsheet cell.

### DETAILED DESCRIPTION

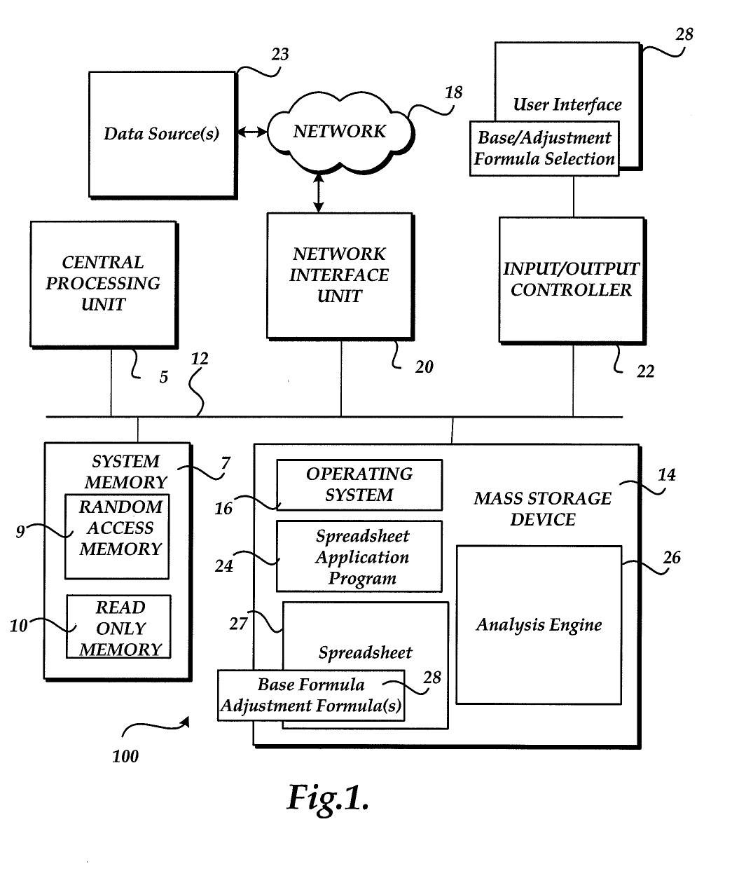

Referring now to the drawings, in which like numerals represent like elements, various embodiments will be described. In particular, FIG. 1 and the corresponding discussion are intended to provide a brief, general description of a suitable computing environment in which embodiments may be implemented.

Generally, program modules include routines, programs, components, data structures, and other types of structures that perform particular tasks or implement particular abstract data types. Other computer system configurations may also be used, including hand-held devices, multiprocessor systems, microprocessor-based or programmable consumer electronics, minicomputers, mainframe computers, and the like. Distributed computing environments may also be used where tasks are performed by remote processing devices that are linked through a communications network. In a distributed computing environment, program modules may be located in both local and remote memory storage devices.

Referring now to FIG. 1, an illustrative computer architecture for a computer 100 utilized in the various embodiments will be described. The computer architecture shown in FIG. 1 may be configured as a desktop or mobile computer and includes a central processing unit 5 (“CPU”), a system memory 7, including a random access memory 9 (“RAM”) and a read-only memory (“ROM”) 10, and a system bus 12 that couples the memory to the CPU 5. A basic input/output system containing the basic routines that help to transfer information between elements within the computer, such as during startup, is stored in the ROM 10. The computer 100 further includes a mass storage device 14 for storing an operating system 16, application programs 24, and other program modules, which will be described in greater detail below.

The mass storage device 14 is connected to the CPU 5 through a mass storage controller (not shown) connected to the bus 12. The mass storage device 14 and its associated computer-readable media provide non-volatile storage for the computer 100. Although the description of computer-readable media contained herein refers to a mass storage device, such as a hard disk or CD-ROM drive, the computer-readable media can be any available media that can be accessed by the computer 100.

By way of example, and not limitation, computer-readable media may comprise computer storage media and communication media. Computer storage media includes volatile and non-volatile, removable and non-removable media implemented in any method or technology for storage of information such as computer-readable instructions, data structures, program modules or other data. Computer storage media includes, but is not limited to, RAM, ROM, EPROM, EEPROM, flash memory or other solid state memory technology, CD-ROM, digital versatile disks (“DVD”), or other optical storage, magnetic cassettes, magnetic tape, magnetic disk storage or other magnetic storage devices, or any other medium which can be used to store the desired information and which can be accessed by the computer 100.

According to various embodiments, computer 100 may operate in a networked environment using logical connections to remote computers through a network 18, such as the Internet. The computer 100 may connect to the network 18 through a network interface unit 20 connected to the bus 12. The network connection may be wireless and/or wired. The network interface unit 20 may also be utilized to connect to other types of networks and remote computer systems. The computer 100 may also include an input/output controller 22 for receiving and processing input from a number of other devices, including a keyboard, mouse, or electronic stylus (not shown in FIG. 1). Similarly, an input/output controller 22 may provide output to a display screen that includes a user interface 28, a printer, or other type of output device. Computer 100 may also be coupled to data source(s) 23 through a network connection 18, and/or some other connection.

As mentioned briefly above, a number of program modules and data files may be stored in the mass storage device 14 and RAM 9 of the computer 100, including an operating system 16 suitable for controlling the operation of a networked personal computer, such as the WINDOWS VISTAS operating system from MICROSOFT CORPORATION of Redmond, Wash. The mass storage device 14 and RAM 9 may also store one or more program modules. In particular, the mass storage device 14 and the RAM 9 may store one or more application programs, such as spreadsheet application 24. For example, spreadsheet program 24 may be the MICROSOFT EXCEL® application.

The analysis engine 26 is operative to evaluate spreadsheet 27. Although shown independent of spreadsheet application 24, analysis engine 26 may be configured as part of spreadsheet application 24. In spreadsheet 27, at least one of the cells has multiple formulas 28 that include a base formula and one or more adjustment formulas that are associated with it. The base formula may actually just be a value instead of a spreadsheet formula. The formulas within spreadsheet 27 may extract data from one or more data sources. For example, the formulas may extract data from internal and/or external data source 23. An internal data source is spreadsheet 27. Other data sources (not shown) may also be accessed. The cells within the spreadsheet that include multiple formulas include a base formula that includes the actual value extracted from the data source, such as data source 23. The other formulas that are associated with that cell represent one or more adjustment formulas that are used for calculating an adjustment to the value contained within the cell. Generally, each of these adjustment formulas represents different calculation scenarios. In response to an update to the spreadsheet 27, each of the formulas associated with each of the cells are dynamically updated and adjusted to react to changes elsewhere in the spreadsheet. In this way, a user can recalculate the spreadsheet and move formulas around in the spreadsheet causing both the base formula and the adjustment formulas that may exist in the same cell to be updated accordingly.

User interface (UI) 28 is designed to provide a user with a visual way to edit formulas associated with spreadsheet 27. For example, UI 28 may be used to edit formulas that are associated with one or more cells within spreadsheet 27. According to one embodiment, UI 28 includes a selectable option indicating when to perform a what-if analysis using one of the adjustment formulas. When a formula within the spreadsheet is edited, analysis engine 26 recalculates the spreadsheet values that are contained within spreadsheet 27.

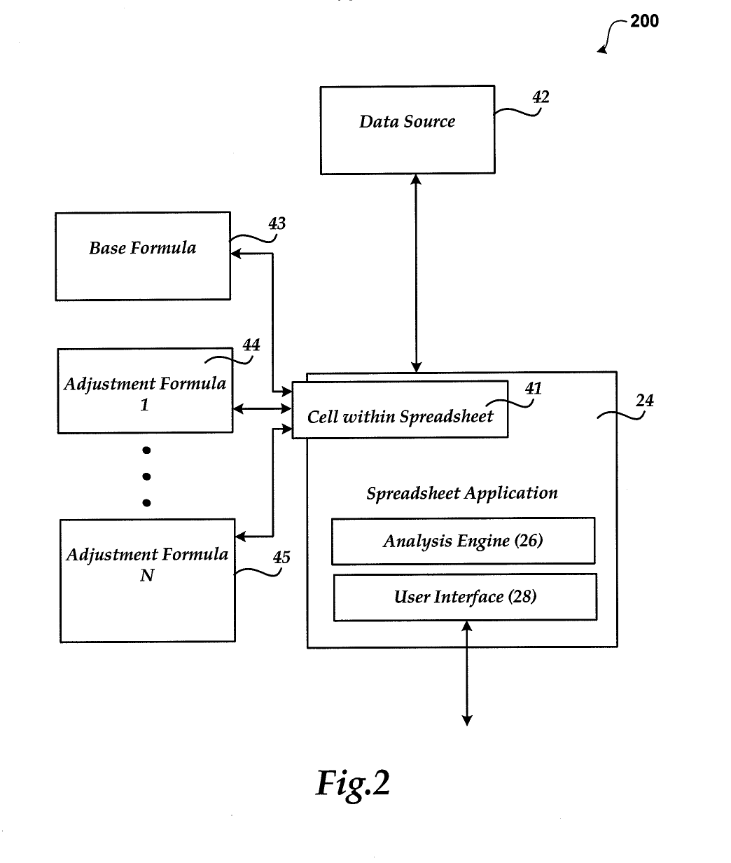

FIG. 2 shows a system for associating multiple formulas with a single spreadsheet cell. As illustrated, spreadsheet system 200 includes spreadsheet application 24 including a cell within a spreadsheet 41, analysis engine 26, user interface (UI) 28, base formula 43, adjustment formulas I-N (43-45) and data source 42.

For illustration purposes, and not intended to be limiting, an example will be described. Suppose, that cell 41 of a spreadsheet has a base formula 43 that is a data extraction formula that extracts data from a data source 42, such as a cube (e.g. =CUBEVALUE(“Adventure Works”, “[Measures]. [Internet Sales Amount]”, “[Product]. [Product Categories]. [All Products]. [Bikes]”)). This base formula 43 may utilize data from a data set which can be external to the spreadsheet application 24 or the data source can simply be data in a different place within the spreadsheet. According to one embodiment, whenever the spreadsheet is recalculated by analysis engine 26, this base formula is reevaluated. When the base formula is reevaluated the data for the data source is accessed again in order to determine if changes have been made to the data source since the last evaluation.

Now suppose that the user wants to be able to adjust the value in the source data retrieved by the base data extraction formula above to see the effect on other values in the source data. According to one embodiment, to do this, the user turns on data input mode using UI 28, which allows the user to enter another formula in the same cell without overwriting the base data extraction formula that has already been entered. Suppose that the adjustment formula 44 entered is “=0.5*(L11+M11).” At this point, the user can analyze the effect of the adjustment on other cells/values and decide to actually write back the change to the data source by selecting an option in UI 28 or discard it to go back to the original value. The adjustment formula can be any type of formula. For example, the adjustment formula could affect aggregation within a summary table that is associated with a data cube. In this example, suppose that the cube included countries at one level, states at another level, and cities at another level. When an adjustment formula changes a value at a state level, then the aggregate value for the country level would change. Similarly, any change at a city level would be aggregated appropriately.

At any time during this typically iterative process, the base formula 43 and the adjustment formula (s) entered for the same spreadsheet cell 41 are maintained and dynamically updated. According to one embodiment, cells having adjusted values are visually marked to let the user know which cells have been adjusted and therefore are not currently showing the value extracted from the data source data but instead show the adjusted value entered as a formula by the user. According to one embodiment, both the base formula and the adjustment formulas are stored within the system memory of the computing device.

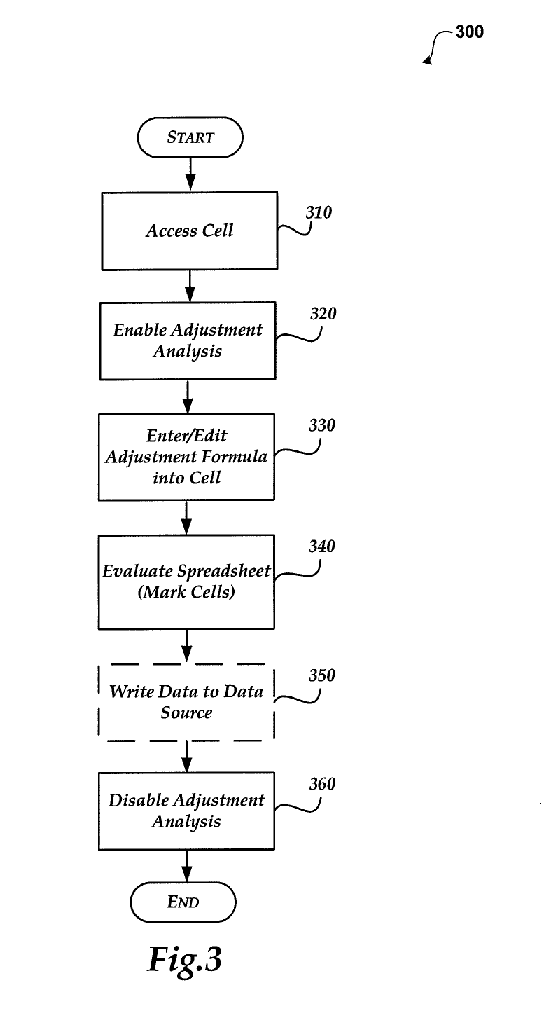

Referring now to FIG. 3, an illustrative process for associating multiple formulas with a single spreadsheet cell is described.

When reading the discussion of the routines presented herein, it should be appreciated that the logical operations of various embodiments are implemented (1) as a sequence of computer implemented acts or program modules running on a computing system and/or (2) as interconnected machine logic circuits or circuit modules within the computing system. The implementation is a matter of choice dependent on the performance requirements of the computing system implementing the invention. Accordingly, the logical operations illustrated and making up the embodiments described herein are referred to variously as operations, structural devices, acts or modules. These operations, structural devices, acts and modules may be implemented in software, in firmware, in special purpose digital logic, and any combination thereof.

After a start operation, the process flows to operation 310 where a cell within a spreadsheet is accessed. While only one cell being accessed is illustrated, any number of cells within the spreadsheet may have multiple formulas. The spreadsheet may be any type of spreadsheet. According to one embodiment, the spreadsheets are Excel® spreadsheets.

Moving to operation 320, adjustment analysis is enabled. According to one embodiment, a user selects an adjustment analysis option using a user interface that is associated with the spreadsheet. For example, a user may select an option that indicates a what-if analysis is to be performed. According to one embodiment, when a what-if analysis is to be performed, no data is extracted by the base formula when the base formula is a data extraction formula. Instead, the data extraction base formula is maintained for later use after the user has finished performing evaluations in the what-if scenario. According to another embodiment, data may be extracted by the data extraction formula even when an what-if-analysis is performed. In this case, the data that is extracted by the base data extraction formula may be displayed in addition to the what-if-analysis value. For example, a user may request to see the extracted data in addition to the what-if-analysis value (e.g. the extracted data is displayed in another window, such as a pop up window). In this way, a user may view the what-if-analysis data in addition to seeing the latest extracted data.

Flowing to operation 330, an adjustment formula that is associated with the cell may be entered and/or edited. The adjustment formula is used to perform a what-if analysis for the spreadsheet. According to one embodiment, the cells within the spreadsheet that are edited are marked such that a user may identify the affected cells.

Transitioning to operation 340, the spreadsheet is evaluated using the results that are associated with the adjustment formula instead of using the base formula for evaluation of the spreadsheet. During the time the spreadsheet is set to perform what-if analysis, the base formula is maintained in memory. According to one embodiment, whenever the spreadsheet is reevaluated each formula that is associated with the cell is also evaluated. For example, during the evaluation of the adjustment formula, the evaluation of the base formula associated with the cell may also be evaluated helping to ensure that the base formula has the latest data. According to another embodiment, the base formula is not evaluated when an adjustment formula is evaluated.

Moving to operation 350, data calculated for the cell during the evaluation of the adjustment formula may be written to the data source accessed by the base formula. According to another embodiment, this option is not available.

Flowing to operation 360, the user interface is used to disable the adjustment analysis at which point the base formula is used for evaluations for the spreadsheet.

The process then flows to an end operation and returns to processing other actions.

The above specification, examples and data provide a complete description of the manufacture and use of the composition of the invention. Since many embodiments of the invention can be made without departing from the spirit and scope of the invention, the invention resides in the claims hereinafter appended.

What is claimed is:

1. A method for performing analysis of a spreadsheet, comprising:
accessing a cell within a spreadsheet; wherein the cell includes a base formula and an adjustment formula; wherein the base formula extracts data from a data source and the adjustment formula represents a different value from the base formula for the cell;
setting the adjustment formula to be an active formula for the cell of the spreadsheet, wherein the active formula is visible for the cell when presented within a display after evaluation of the spreadsheet;
evaluating the spreadsheet to determine a result for the adjustment formula, wherein evaluating the spreadsheet includes evaluating the adjustment formula and maintaining the base formula during the evaluation of the adjustment formula; and
presenting the result in the display, such that the result shows the result of the adjustment formula and its effect on dependent cells within the spreadsheet.

2. The method of claim 1, further comprising entering the adjustment formula and associating the adjustment formula with the cell.

3. The method of claim 2, further comprising setting an option within the spreadsheet indicating to make the adjustment formula the active formula for the cell within the spreadsheet.

4. The method of claim 3, further comprising evaluating the base formula in addition to evaluating the adjustment formula.

5. The method of claim 4, further comprising marking cells within the spreadsheet that were altered due to the evaluation of the adjustment formula.

6. The method of claim 3, wherein setting the option is activated by receiving an input through a user interface that is associated with the spreadsheet.

7. The method of claim 3, wherein evaluating the base formula in addition to the adjustment formula when the spreadsheet is evaluated comprises automatically evaluating the base formula when the spreadsheet is evaluated and the adjustment formula is the active formula for the spreadsheet and automatically evaluating the adjustment formula when the base formula is the active formula for the spreadsheet.

8. The method of claim 4, further comprising presenting an option to write the result for the adjustment formula to the data source at a same location as the data extracted for the base formula.

9. A computer-readable storage medium having computer-executable instructions for dynamically updating a base formula and an adjustment formula that are associated with a single cell within a spreadsheet; comprising:
determining an active formula for the cell; wherein the active formula is determined from either the base formula or the adjustment formula; wherein the base formula extracts data from a data source and the adjustment formula is a different value from the base formula for the cell;
evaluating the spreadsheet to determine a result for the active formula, wherein evaluating the spreadsheet includes evaluating both the adjustment formula and base formula; and
presenting the result in the display, such that the result shows the result of the active formula and its effect on dependent cells within the spreadsheet.

10. The computer-readable storage medium of claim 9, further comprising associating the adjustment formula with the cell when the adjustment formula is entered into the cell of the spreadsheet through a user interface.

11. The computer-readable storage medium of claim 10, wherein determining the active formula for the cell comprising determining an option selected through the user interface that indicates when to use the base formula and when to use the adjustment formula.

12. The computer-readable storage medium of claim 11, wherein the data source is an external data source to the spreadsheet.

13. The computer-readable storage medium of claim 12, wherein evaluating both the adjustment formula and base formula comprises automatically evaluating the base formula when the spreadsheet is evaluated and the adjustment formula is the active formula for the spreadsheet and automatically evaluating the adjustment formula when the base formula is the active formula for the spreadsheet;
wherein evaluating the base formula includes accessing the external data source to retrieve the latest data for the base formula.

14. The computer-readable storage medium of claim 12, further comprising writing the result of the active formula back to the external data source when the active formula is the adjustment formula to a same location of the external data source as a location from which the data is extracted for the base formula.

15. A system for evaluating a spreadsheet, comprising:
a display;
a processor a memory and a computer-readable medium;
an operating environment stored on the computer-readable medium and executing on the processor;
a data source that is configured to store data;
a spreadsheet application that includes a user interface and an analysis engine that is configured to:
access a spreadsheet that includes cells, wherein at least one of the cells includes multiple distinct formulas that are evaluated independently, wherein the multiple formulas include a base formula and an adjustment formula; wherein the base formula extracts data from the data source and the adjustment formula represents a different value from the base formula for the cell;
determine an active formula for the cell and an inactive formula for the cell; wherein the active formula is selected from the adjustment formula and the base formula; and wherein the inactive formula is the non-selected formula;
evaluate the spreadsheet using the active formula for the cell;
maintain the inactive formula in the memory during the evaluation of the active formula; and
present results of the evaluation of the active formula within the display while continuing to maintain the inactive formula.

16. The system of claim 15, further comprising entering the adjustment formula within the user interface and associating the adjustment formula with the cell.

17. The system of claim 16, further comprising receiving an option set using the user interface indicating to make the adjustment formula the active formula for the cell within the spreadsheet.

18. The system of claim 17, further comprising evaluating the base formula in addition to the adjustment formula when the spreadsheet is evaluated; wherein evaluating the base formula includes accessing the data source to determine if the extracted value has changed.

19. The system of claim 17, wherein evaluating the base formula in addition to the adjustment formula when the spreadsheet is evaluated comprises automatically evaluating the base formula when the spreadsheet is evaluated and the adjustment formula is the active formula for the spreadsheet and automatically evaluating the adjustment formula when the base formula is the active formula for the spreadsheet.

20. The system of claim 17, further comprising presenting an option to write the result for the adjustment formula to the data source at a same location as the data extracted for the base formula.
